(19) United States
(12) Patent Application Publication
(10) Pub. No.: US 2005/0199130 A1
(43) Pub. Date: Sep. 15, 2005

(54) Portable coffee maker

(75) Inventors: Jeffrey William Palese, North Ridgeville, OH (US); John Peter Dobeck, Newburgh Heights, OH (US); Robert Jeffrey Browning, Middleburg Heights, OH (US); Ming Zeng, Dayton, OH (US)

Correspondence Address: TAROLLI, SUNDHEIM,;COVELL & TUMMINO LLP, Suite 1111, 526 Superior Avenue, CLEVELAND, OH, 44114, US

(73) Assignee: Pragotrade USA, Incorporated

(21) Appl. No.: 11/063,938

(22) Filed: Feb. 23, 2005

Related U.S. Application Data
(60) Provisional application No. 60/546,874, filed on Feb. 23, 2004.

(51) Int. Cl. A23F 3/00

(52) U.S. Cl. 99/279

(57) ABSTRACT

An apparatus (10) for preparing a hot beverage includes a housing (12) comprising a burner chamber (40) and a reservoir (20) for storing a volume of liquid. A burner (42) is disposed in the burner chamber (40). A heating coil (92) in fluid communication with the reservoir (20). The heating coil (92) has a portion (100) disposed in the burner chamber (40). A filter assembly (30) supports a filter basket (34) and a beverage flavoring substance disposed in the filter basket. The burner (42) is operable to burn a combustible fuel gas in the chamber (40) to heat the liquid in the heating coil (92). The heating coil (92) directs heated liquid toward the filter assembly (30). The heated liquid passes through the filter means (30) and combines with the beverage flavoring substance to produce the hot beverage.

### RELATED APPLICATIONS

This application claims the benefit of U.S. Provisional Application No. 60/546,874, filed on Feb. 23, 2004.

### FIELD OF THE INVENTION

The present invention relates to an apparatus for preparing a hot beverage. In one embodiment, the present invention relates to a gas-powered portable coffee maker.

### SUMMARY OF THE INVENTION

The present invention relates to an apparatus for preparing a hot beverage includes a housing comprising a burner chamber and a reservoir for storing a volume of liquid. A burner is disposed in the burner chamber. A heating coil in fluid communication with the reservoir. The heating coil has a portion disposed in the burner chamber. A filter assembly supports a filter basket and a beverage flavoring substance disposed in the filter basket. The burner is operable to burn a combustible fuel gas in the chamber to heat the liquid in the heating coil. The heating coil directs heated liquid toward the filter assembly. The heated liquid passes through the filter means and combines with the beverage flavoring substance to produce the hot beverage.

The present invention also relates to an apparatus for preparing a hot beverage. The apparatus includes a burner and a fuel gas source for supplying fuel gas to the burner. A filter assembly supports a beverage flavoring substance. A heating coil has a portion positioned near the burner and a portion for directing heated liquid to the filter assembly. A reservoir stores a volume of liquid. The reservoir is separate and removable from the remainder of the apparatus and includes an outlet for directing liquid into the heating coil. The outlet includes a valve having a closed position preventing fluid flow from the reservoir when the reservoir is removed. The valve is actuatable to an opened position permitting fluid flow from said reservoir into said heating coil when the reservoir is assembled with the remainder of the apparatus.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a perspective view of an apparatus for preparing a hot beverage, according to an embodiment the present invention.

FIG. 2 is an exploded perspective view of the apparatus for preparing a hot beverage.

FIG. 3 is a perspective view of the apparatus including a protective cover.

FIG. 4 is a sectional view of the apparatus for preparing a hot beverage.

### DESCRIPTION OF AN EMBODIMENT

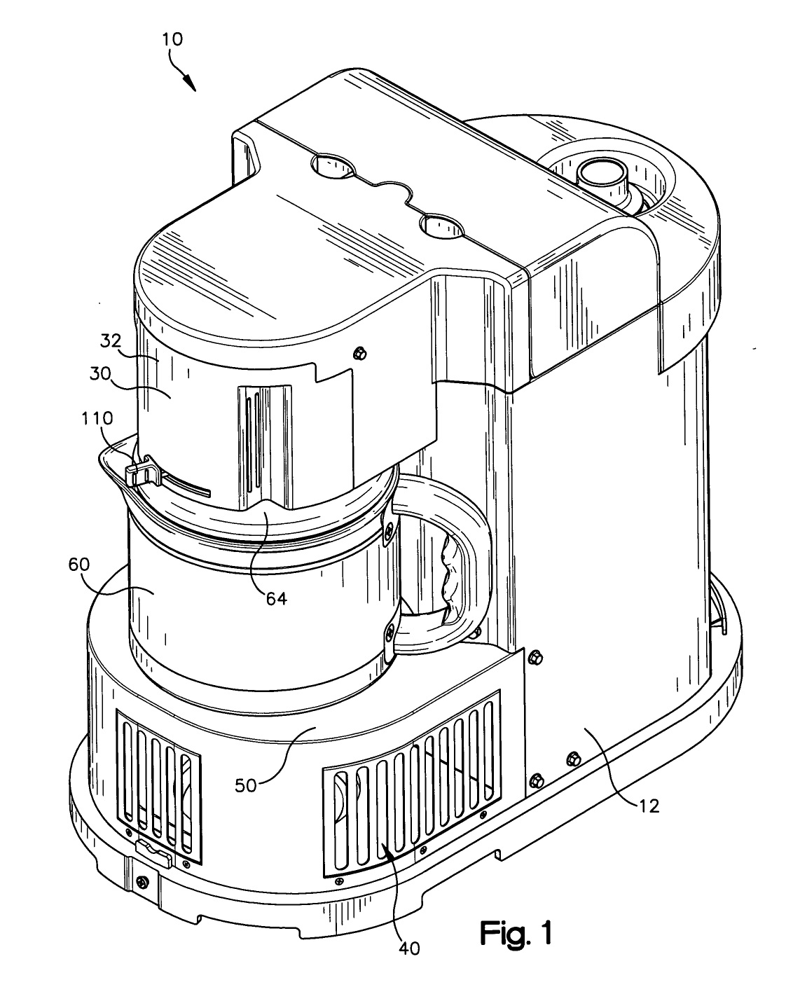

Representative of the present invention, an apparatus 10 for preparing a hot beverage includes a housing 12. In the embodiment illustrated in FIGS. 1-4, the apparatus 10 may comprise a coffee maker. The apparatus 10 includes a reservoir 20, a filter assembly 30, and a burner chamber 40, each of which may be included as integral parts of the housing 12 or separate parts supported by the housing. The apparatus 10 also includes a pad 50 for supporting a serving vessel 60, such as a carafe.

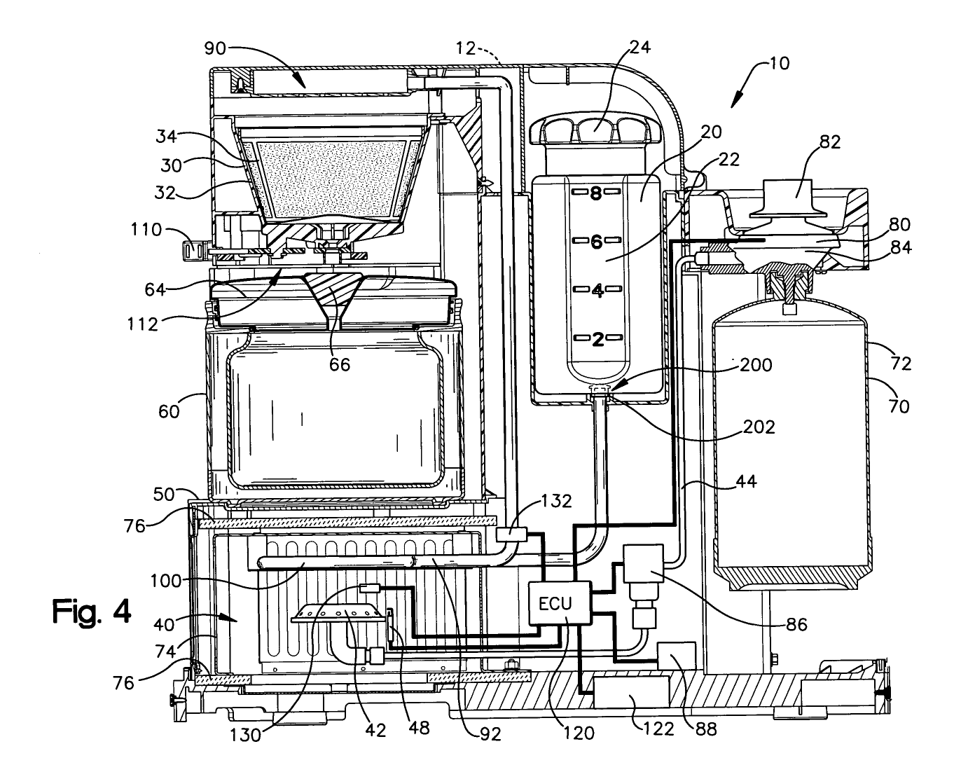

A burner 42 (FIG. 4) is supported in the burner chamber 40 and is connectable with a fuel gas source 70 via a fuel line 44. As shown in the illustrated embodiment, the fuel gas source 70 may comprise a container 72, such as a bottle, that contains a pressurized fuel gas, such as propane or butane. The container 72 may be disposable or refillable. As an example, the fuel gas source 70 can be a conventional disposable fuel canister containing propane under pressure. These conventional fuel canisters are commonly used as a fuel source for camping stoves, lanterns, and for heat torches.

The housing 12 is constructed of a material, such as metal or plastic, that is capable of withstanding exposure to heat. One such material is high-density polyethylene (HDPE). The burner chamber 40 may be lined or otherwise surrounded (completely or partially) by an insulating or fire retardant wall 74. The apparatus 10 may also include one or more heat shields 76 constructed of a heat and fire resistant material, such as a ceramic material.

A regulator 80 controls the flow of fuel gas from the source 70. The regulator 80 may include means 82, such as a dial, for operating a gas flow valve 84. The valve 84 may be a two-position full-opened/full-closed valve or may be a control valve that allows for varying the rate at which fuel gas flows to the burner 42. The regulator 80 may thus be operable to control combustion of the fuel gas at the burner 42. The apparatus 10 may, however, include alternative means for controlling gas flow to the burner 42, some of which are described below.

The regulator 80 may also include a control or safety shutoff valve 86 for controlling the supply of fuel gas flow to the burner 42. The control valve 86 may, for example, comprise a valve, such as a solenoid valve, that is closed automatically upon the occurrence of an event for which fuel gas shut-off is desired, such as if the apparatus 10 is tilted beyond a predetermined angle from the normal vertical position illustrated in FIGS. 1-4. The safety shutoff valve 86 may thus shut down the burner 42 if, for example, the apparatus 10 is knocked over. Indication of such a tilt condition may be provided by a tilt switch 88.

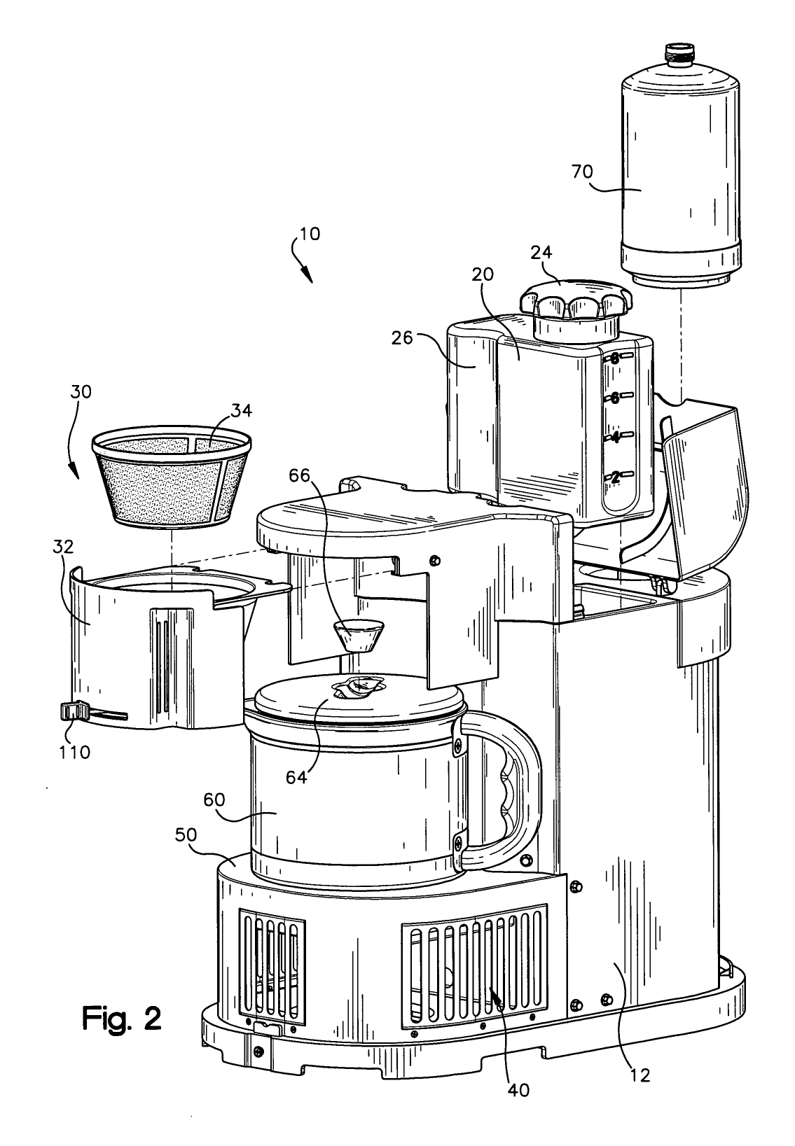

The reservoir 20 forms a volume for containing or storing a volume of liquid, such as water. As shown in FIG. 2, the reservoir 20 may include means 22, such as a sight glass, for monitoring the fluid level in the reservoir. The carafe 60 may have a similar means (not shown) for monitoring the fluid level in the carafe. The capacity of the reservoir 20 may be about equal to the capacity of the carafe 60. This capacity may, for example, be up to 12-16 cups or more.

The carafe 60 can have a variety of constructions. In one construction, the carafe 60 is constructed of double walled stainless steel with an insulating material disposed between the walls (see FIG. 4). This construction provides an insulating effect that can allow the carafe 60 to maintain the temperature of its contents for extended periods of time.

The carafe 60 may also include a detachable lid 64 that can be secured to the carafe by means (not shown) such as screw threads. In this configuration, the lid 64 can, for example, be screwed tight to help prevent spillage and to help maintain the temperature of any beverage contained therein. The lid 64 can be unscrewed to allow for dispensing the beverage. The lid 64 can include a plug 66 that is removable to permit liquids to pass through the lid to fill the carafe 60. The plug 66, when installed in the lid 64, blocks liquids from escaping through the valve should the carafe 60 be tipped or knocked over and also helps improve the insulation of the carafe.

The reservoir 20 may be readily detachable and removable from the housing 12 to provide convenience in filling the reservoir. In this instance, the reservoir 20 may include a removable closure member 24, such as a threaded cap or lid. The reservoir 20 may thus be a substantially closed vessel, which can be advantageous in the event that the apparatus 10 is tipped or knocked over. The reservoir 20 may also include a handle portion 26 for facilitating ease and convenience in transporting, filling, and cleaning the reservoir.

The filter assembly 30 includes a filter support housing 32 that is supported on the housing 12. The filter support housing 32 has an interior in which a filter basket 34 may be supported. The filter support housing 32 may be movable or removable to allow the filter basket 34 to be removed for purposes, such as cleaning or filling. The filter basket 34 is adapted to receive a volume of a beverage flavoring substance, such as ground coffee beans. The filter basket 34 is constructed to have a porous side wall and/or bottom wall formed from a material, such as a stainless steel wire mesh material. The filter basket 34 could, however, have alternative constructions and could, for example, include a disposable paper filter.

The apparatus 10 may also include a drip assembly 90 positioned above the filter assembly 30. A tubular heating coil 92 provides fluid communication between the reservoir 20 and the drip assembly 90. The heating coil 92 has a first end connected with an outlet 200 of the reservoir 20 and an opposite second end connected with the drip assembly 90. A back flow prevention device (not shown), such as a check valve, may be included to help prevent back flow of liquid from the drip assembly 90 into the heating coil 92. A drain plug (not shown) may be included to allow drainage of the reservoir 20 and the heating coil 92.

The outlet 200 of the reservoir 20 comprises a valve that opens automatically upon installation of the reservoir in the apparatus 10. As shown in FIG. 4, the outlet 200 includes valve member 202, such as a plunger, that is spring biased to a closed position in which fluid flow from the reservoir 20 is prevented. When the reservoir 20 is installed in the apparatus 10, a portion of the apparatus, such as the first end of the heating coil 92, engages the valve member 202. This urges the valve member 202 against the spring bias to an opened position in which fluid flow from the reservoir 20 through the outlet 200 is permitted.

The heating coil 92 has a portion 100 positioned in the burner chamber 40 generally above the burner 42. The portion 100 of the heating coil 92 in the burner chamber 40 may be wound, coiled, bent, or otherwise arranged in a back and forth manner such that a desired length of the heating coil is positioned in the chamber. The heating coil 92 may be constructed of any suitable material capable of withstanding high temperatures, such as copper or stainless steel.

To operate the apparatus 10, the fuel gas source 70 is installed using known connectors to thereby connect the fuel gas source to the fuel line 44. The reservoir 20 is then filled with an appropriate volume of liquid, e.g., water, capped off with the lid 24, and installed in the housing 12. Once the reservoir 20 is installed, the water enters the heating coil 92 via the outlet 200. The filter assembly 30 is opened and an appropriate amount of the beverage flavoring substance, e.g., coffee, is placed in the filter basket 34. The filter assembly 30 is then placed in the closed position, thereby positioning the filter basket 34 beneath the drip assembly 90.

The carafe 60 is positioned on the pad 50 with the lid 64 screwed on. The carafe 60, when positioned on the pad 50, is positioned beneath a drip prevention assembly 112 of the apparatus 10. The drip prevention assembly 112 includes an actuator 110 that is movable to actuate the drip prevention assembly from a closed condition to an open condition. In the closed condition, the drip prevention assembly 112 prevents liquid from flowing from the filter assembly 30, which allows the carafe 60 to be removed from the pad 50 during the brewing process. In the opened condition, liquid can flow through the drip prevention assembly 112 and into the carafe 60.

The gas flow control valve 84 may be opened to a desired position through operation of the dial 82. The burner 42 can then be lit manually using an external flame source, such as a lighter or match, or can be lit through means such as an integrated ignition source 48. Such an integrated ignition source 48 may be an electrostatic igniter mechanically operable via a pushbutton (not shown), or a battery powered electronic ignition operable via an electrical circuit. The integrated ignition source 48 produces a spark, i.e., an electrical arc, between an anode and a cathode to ignite the fuel at the burner 42. Once the burner 42 is lit, the flame can be adjusted to a desired level using the dial 82 to regulate the gas flow control valve 84. Alternatively, where the valve 84 has a full-opened/full-closed configuration, the flame may have a single preset level.

The flame produced at the burner 42 acts on the portion 100 of the heating coil 92 in the burner chamber 40. This heats the water in the heating coil, which causes the heated water to rise into the drip assembly 90. As heated water flows from the heating coil 92 into the drip assembly 90, water enters the heating coil from the reservoir 20 and is heated. This brewing process continues until all or most of the water in the reservoir 20 flows through the heating coil 92, is heated in the burner chamber 40, and flows into the drip assembly 90.

The heated water is directed from the drip assembly 90 onto the coffee grounds in the filter basket 34. The hot water passes through the coffee grounds, through the filter basket 34, and is directed out of the filter assembly 30 into the serving vessel 60. As the hot water passes through the coffee grounds, the water is flavored by the by the coffee grounds.

Referring to FIG. 4, the apparatus 10 may also include an electronic control module 120. The control module 120 may comprise any suitable control device or devices, such as electronic controllers, microprocessors, solid state devices, discrete analog/digital circuitry, etc. The control module 120 helps control operation of the apparatus 10, more particularly, helps control combustion of the fuel gas in the burner chamber 40. The control module 120 may be powered by means 122 such as a battery. The control module 120 may be operative to control actuation of the control valve 86 and thereby control the flow of fuel gas to the burner 42.

The control module 120 may be operatively connected with devices for providing input that relates to the status of the apparatus 10. The control module 120 may use this input to control operation of the apparatus 10. For example, the control module 120 may be operatively connected with a thermocouple 130 or other heat/flame detecting device that provides input as to whether there is a flame at the burner 42. The control module 120 also may be operatively connected with a thermocouple 132 that provides input as to the temperature in the heating coil 92 and, more specifically, water in the portion 100 of the heating coil.

The control module 120 may be operative to provide automated operation of the apparatus and may also provide features that otherwise may not be included in the apparatus. The control module 120 is operatively connected to the regulator 80. Operation of the control module 120 may be triggered by opening the valve 84 via the knob 82. Similarly, when the valve 84 is closed, the control module 120 may be shut down.

Upon opening the valve 84 manually, the control module 120 controls operation of the apparatus 10 based on information received through the various I/O devices of the apparatus. More specifically, the control module 120 is operative to control the ignitor 48 and the control valve 86 based on inputs supplied via regulator 80 the control panel and inputs supplied from devices, such as the thermocouples 130 and 132 and tilt switch 88.

In operation, the apparatus 10 may powered on/off manually via the regulator 80. Once activated, the control module 120 may be operative to actuate the control valve 86 and ignitor 48 to light the burner 42 and thereby produce the hot beverage (e.g., coffee), as described above. Once the coffee is brewed, the control module 120 may then close the gas flow valve 84 to shut down the burner 42. This may be accomplished, for example, by detecting an increased coil temperature via the thermocouple 132.

During operation, the control module 120 may respond to conditions sensed by the various I/O devices of the apparatus 10. For example, the control module 120 may be operative to close the control valve 86 if a flame is not detected within a certain time after ignition of the burner 42 is requested. The control module 120 may also be operative to modulate or close the control valve 86 if the temperature in the portion 100 of the heating coil 92 rises above a predetermined level.

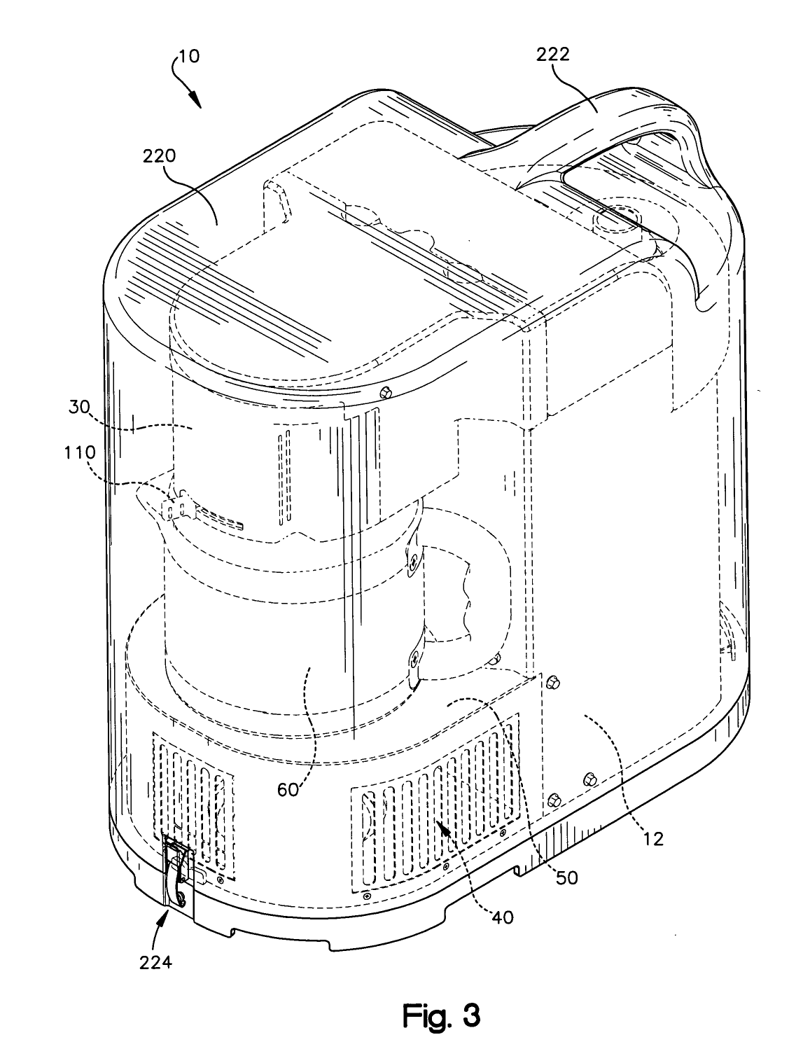

Referring to FIG. 3, the apparatus 10 may include a cover 220 for at least partially enclosing the apparatus to help form a protective cover for use while storing or transporting the apparatus. The cover 220 includes clasping mechanisms 224 that secure the cover to the housing 12. The cover 220 also includes a handle portion 222 for facilitating ease in carrying the apparatus 10.

From the above description of the invention, those skilled in the art will perceive improvements, changes and modifications. For example, the apparatus 10 may include additional means, such as a timer or a reservoir level switch, for further controlling fuel gas combustion. Such improvements, changes and modifications within the skill of the art are intended to be covered by the appended claims.

1. An apparatus for preparing a hot beverage, said apparatus comprising:
a housing comprising a burner chamber and a reservoir for storing a volume of liquid;
a burner disposed in said burner chamber;
a heating coil in fluid communication with said reservoir, said heating coil having a portion disposed in said burner chamber; and
a filter assembly for supporting filter means and a beverage flavoring substance disposed in said filter means;
said burner being operable to burn a combustible fuel gas in said chamber to heat the liquid in said heating coil, said heating coil directing heated liquid toward said filter assembly, said heated liquid passing through said filter means and combining with said beverage flavoring substance to produce the hot beverage.

2. The apparatus recited in claim 1, further comprising a fuel gas source comprising a container for containing a volume of fuel gas under pressure, said apparatus comprising means for connecting with said fuel gas source to provide fuel gas to said burner.

3. The apparatus recited in claim 1, further comprising a serving vessel removably supported beneath said filter assembly, said serving vessel being for receiving the hot beverage after it passes through said filter assembly.

4. The apparatus recited in claim 3, further comprising means actuatable to prevent fluid flow from said filter assembly when said serving vessel is absent from being supported beneath said filter assembly.

5. The apparatus recited in claim 3, wherein said serving vessel includes a removable lid comprising a stopper removable to permit liquid to flow into said serving vessel, said stopper being insertable into said lid to help prevent spillage from said serving vessel and to help improve thermal insulation of said serving vessel.

6. The apparatus recited in claim 1, wherein said reservoir comprises a container separate from said housing and removable from said housing.

7. The apparatus recited in claim 6, wherein said container includes a handle portion and a removable lid.

8. The apparatus recited in claim 6, wherein said container comprises an outlet for directing liquid into said heating coil, said outlet comprising valve means having a closed position preventing fluid flow from said reservoir when said reservoir is removed from said housing, said valve means being actuatable to an opened position permitting fluid flow from said reservoir into said heating coil when said reservoir is installed in said housing.

9. The apparatus recited in claim 1, wherein said fuel gas comprises one of propane and butane.

10. The apparatus recited in claim 1, further comprising means for regulating the supply of fuel gas to said burner, said regulating means comprising a valve for controlling the flow of said fuel gas to said burner.

11. The apparatus recited in claim 1, further comprising means for shutting down said burner when said reservoir is empty.

12. The apparatus recited in claim 1, further comprising means for shutting down said burner when said housing tilts beyond a predetermined angle.

13. The apparatus recited in claim 1, further comprising ignition means for igniting said burner.

14. The apparatus recited in claim 1, wherein said housing further comprises a drip assembly supported above said filter assembly, said heating coil delivering said heated liquid into said drip assembly, said drip assembly being adapted to deliver said heated liquid into said filter assembly.

15. The apparatus recited in claim 1, further comprising a cover connectable with said housing, said cover at least partially enclosing the apparatus to help protect portions of the apparatus.

16. The apparatus recited in claim 15, wherein said cover includes a handle portion.

17. An apparatus for preparing a hot beverage, said apparatus comprising:
a burner;
a fuel gas source for supplying fuel gas to said burner;
a filter assembly for supporting a beverage flavoring substance;
a heating coil having a portion positioned near said burner and a portion for directing heated liquid to said filter assembly; and
reservoir means for storing a volume of liquid, said reservoir means being separate and removable from the remainder of the apparatus and including an outlet for directing liquid into said heating coil, said outlet comprising valve means having a closed position preventing fluid flow from said reservoir when said reservoir is removed, said valve means being actuatable to an opened position permitting fluid flow from said reservoir into said heating coil when said reservoir is assembled with the remainder of the apparatus.
